(19) United States
(12) Patent Application Publication
(10) Pub. No.: US 2015/0255058 A1
(43) Pub. Date: Sep. 10, 2015

(54) METHOD FOR DETERMINING WHETHER A MEASURED SIGNAL MATCHES A MODEL SIGNAL

(71) Applicant: THE SECRETARY OF STATE FOR DEFENCE, Salisbury, Wiltshire (GB)

(72) Inventors: Josef Roger Kornycky, Salisbury (GB); David Christopher Ferrier, Salisbury (GB)

(21) Appl. No.: 14/438,671

(22) PCT Filed: Nov. 20, 2013
(86) PCT No.: PCT/GB2013/000501

§ 371 Date: Apr. 27, 2015

(30) Foreign Application Priority Data
Nov. 21, 2012 (GB) 1220907.8

(51) Int. Cl. G10L 15/08; G10L 15/20

(52) U.S. Cl. CPC G10L 15/08; G10L 15/20

(57) ABSTRACT

There is provided a method for determining whether a measured signal matches a model signal, for example for use in speech or speaker recognition. The method comprises obtaining values of statistical features for the model signal; obtaining values of the statistical features for the measured signal; obtaining a signal to noise ratio of the measured signal; and comparing the values of the statistical features for the model signal to the values of the statistical features for the measured signal according to the signal to noise ratio of the measured signal, to determine whether the measured signal matches the model signal. There is further provided a signal processor configured to implement the method for determining whether a measured signal matches a model signal.

### TECHNICAL FIELD OF THE INVENTION

This invention relates to a method for determining whether a measured signal matches a model signal, for example for use in speech or speaker, recognition.

### BACKGROUND TO THE INVENTION

There are many signal processing situations in which it is desired to determine whether or not a measured signal matches a model signal, for example the model signal may be a signal which is being searched for, such as a signal corresponding to a particular vocal word for speech recognition, a signal corresponding to the voice of a particular person for speaker recognition, or a particular system signal that is symptomatic of the occurrence of a fault in an electrical system. The measured signal may be a signal which potentially corresponds to the signal being searched for, such as a signal from a microphone, or a signal from an electrical system.

One of the problems with matching measured signals to model signals is that the matching effectiveness can be badly compromised in the presence of noise in the measured or the model signal.

For example, a known speaker recognition system may be trained to recognise particular speakers. An electrical signal from a microphone when a known speaker speaks a phrase rich in phonemes may be recorded as a model signal corresponding to the speaker. The speaker recognition system may extract features from the model signal, such as Mel Frequency Cepstral Coefficients (MFCCs), and analyse them. If the MFCCs found in the model signal match the MFCC's found in a later recording by an unknown speaker, then the unknown speaker may be determined to be the same speaker who spoke to generate the model signal.

However, the model signal is likely to include noise from any background sounds present in the environment in which the speaker speaks. Furthermore, once the speaker recognition system has been trained to recognise a particular speaker and is put into use, if the speaker later speaks when a different amount of noise is present to when the model signal was recorded, then the system may fail to recognise the particular speaker, due to the differing amounts of noise

It is therefore an aim of the invention to improve upon the known art.

### SUMMARY OF THE INVENTION

According to an embodiment of the invention, there is provided a method for determining whether a measured signal matches a model signal. The method comprises:
obtaining values of statistical features for the model signal;
obtaining values of the statistical features for the measured signal;
obtaining a signal to noise ratio of the measured signal; and
comparing the values of the statistical features for the model signal to the values of the statistical features for the measured signal according to the signal to noise ratio of the measured signal to determine whether the measured signal matches the model signal.

The statistical features for which values are obtained for the model signal are the same statistical, features for which values are obtained for the measured signal. For example, if a first one of the statistical features is the variance of a signal, then the value of the first statistical feature for the model signal is the variance value of the model signal, and the value of the first statistical feature for the measured signal is the variance value of the measured signal.

Since the method operates on statistical features of the signals, rather than the actual waveform shapes of the signals, it is possible to obtain more accurate matching between the signals if the signal to noise ratio of the measured signal is taken into account when comparing the values of the statistical features for the model signal to the values of the statistical features for the measured signal.

In particular, a given signal waveform will be randomly affected by noise, but it is often possible to predict how the value of a statistical feature of the given signal waveform will vary with the noise. The noise tends to move the value of the statistical feature of the given signal waveform closer to the value of the statistical feature of the noise, which is normally known. For example, if the given signal waveform has a particular value of variance, then it can be predicted that the value of variance of the given signal waveform will increase for lower signal to noise ratios of the given signal waveform since noise typically has a very large variance value. The. amount that the values of the statistical features for the measured signal move towards the values of the statistical features for a noise signal clearly depends upon the signal to noise ratio of the measured signal.

This prediction of how a particular statistical feature will vary with signal to noise ratio can be used to deliver a significant improvement in the matching process, particularly when a large amount of noise is present. For example, if the variance value of the model signal is (S1+S2)/2, then the measured signal may be determined as matching the model signal if the variance value of the measured signal is between S1 and S2 when there is below a threshold level of noise in the measured signal, and the measured signal may be determined as matching the model signal if the variance value of the measured signal is between S1+1 and S2+1 when there is greater than the threshold amount of noise present in the measured signal.

Thus, a measured signal with a variance value of S2−0.5 under low noise conditions, the measured signal corresponding to the matched signal, is still correctly matched to the model signal under high noise conditions that raise the variance value of the measured signal up to S2+0.5, because the variance range is moved up to between S1+1 and S2+1 under the high noise conditions. Furthermore, a measured signal with a variance value of S1−0.5 under low noise conditions, the measured signal not corresponding to the model signal, is not incorrectly matched to the model signal under high noise conditions that raise the variance value of the measured signal up to S1+0.5, because the variance range is moved up to between S1+1 and S2+1 under the high noise conditions.

In the above example S1 and S2 are integer values, S1 being less than S2. As an alternative to increasing the range to between S1+1 and S2+1 under high noise conditions, the range could be left at between S1 and S2 for all noise conditions, with a value of 1 being subtracted from the variance value of the measured signal under the high noise conditions before the variance value of the measured signal is compared to the range of between S1 and S2.

The values of the statistical features for the model signal may for example be obtained by receiving them as a template comprising the values of the statistical features for the model signal. Multiple templates corresponding to multiple respective model signals may be received for determining whether the measured signal matches any one of the model signals. The values of the statistical features for the model signal may be extracted from the model signal if the model signal itself is received rather than the values of the statistical features.

The obtaining the values of the statistical features for the measured signal may comprise receiving the measured signal and extracting the values of the statistical features from. the measured signal. Alternatively, the values of the statistical features for the measured signal may be received directly, for example if the measured signal has already been received elsewhere and the values of the statistical features for the measured signal have already been extracted.

The obtaining the, signal to noise ratio of the measured signal may comprise receiving the measured signal and estimating the signal to noise ratio of the measured signal. Alternatively, the signal to noise ratio of the measured signal may be received directly, for example if the measured signal has already been received elsewhere and the value of the signal to noise ratio has already been estimated. Many methods of estimating signal to noise ratio are known to those skilled in the art, and so these will not be discussed any further here.

Advantageously, the step of comparing the values of the statistical features for the model signal to the values of the statistical features for the measured signal according to the signal to noise ratio of the measured signal, may comprise adjusting the values of the statistical features for the measured signal according to the signal to noise ratio of the measured signal, and comparing the adjusted values to the values of the statistical features for the model signal to determine whether the measured signal matches the model signal.

Alternatively, the step of comparing may comprise adjusting the values of the statistical features for the model signal according to the signal to noise ratio of the measured signal, and comparing the adjusted values to the values of the statistical features for the measured signal to determine whether the measured signal matches the model signal. However, it is normally more efficient to adjust the values of the statistical features for the measured signal since there is only one measured signal, whereas there may be many different model signals each having a corresponding set of values of the statistical features.

The measured signal is determined to match the model signal if the adjusted values of the statistical features for the measured signal sufficiently match the values of the statistical features for the model signal.

Various known pattern matching/recognition techniques for comparing the set of adjusted values of the statistical features for the measured signal to the values of the statistical features for the model signal, to determine whether or not there is a match between the measured signal and the model signal, will be apparent to those skilled in the art.

For example, the square of the difference between the adjusted value for the measured signal and the value for the model signal could be taken for each statistical feature, and then the squared differences added together and compared to a threshold to determine whether there is a match or not.

In another example discussed in more detail later herein, the value of each statistical feature of the model signal may be described in terms of a model of the statistical feature, the model defining an acceptance range, the adjusted value of the statistical feature for the measured signal being considered to match the value of the statistical feature for the model signal if the adjusted value of the statistical feature for the measured signal falls within the acceptance range.

Advantageously, the values of the statistical features may be adjusted according to respective adjustment trends that are associated with the statistical features, each adjustment trend predicting how the value of the associated statistical feature for the measured signal will vary according to the signal to noise ratio of the measured signal. Then, the adjustment trend can be used to provide an accurate amount of adjustment for virtually any given level of signal to noise ratio. Alternatively, the step of adjusting may provide a level of adjustment according to which one of a few different ranges of signal to noise ratio that the signal to noise ratio of the measured signal falls within. The adjustment may be applied to the values of the statistical features of the model signal, or to the values of the statistical features of the model signal, so that the values of the statistical features of the model signal are compared to the values of the statistical features of the model signal in effect at the same signal to noise ratio as a result of the adjustment.

Since the model signal and the measured signal are the same as one another under ideal conditions, their statistical features are affected by noise in substantially the same way as one another. Accordingly, each adjustment trend may be determined by adding various levels of noise to the model signal and extracting values of the associated statistical feature for the model signal at the various levels of noise to see how the values of the associated statistical feature for the model signal vary with signal to noise ratio. This may be useful in applications where measured signals at a wide range of signal to noise ratio are not readily available. The type of noise added to the model signal is typically white noise, although other types of noise could be added if it is known beforehand that the measured signal is likely to be affected by the other types of noise, e.g. pink, brown, etc.

Each adjustment trend may additionally, or alternatively, be determined by:
measuring values of the associated statistical feature for multiple signals, wherein each one of the multiple signals has the associated statistical feature measured at a range of signal to noise ratios;
determining an individual trend for each one of the multiple signals, each individual trend predicting how the value of the associated statistical feature will vary according to the signal to noise ratio of the one of the multiple signals; and
determining the adjustment trend according to the average of the individual trends.

The multiple signals preferably comprise model signals or measured signals, or measured signals and model signals. The multiple signals may include signals that do not correspond to the model signal. Then, an adjustment trend can be determined even if signals that are known to correspond to the model signal are not readily available, and an adjustment trend of the associated statistical feature does not need to be determined and stored for each different model signal that is being searched for, but a single adjustment trend may be determined and stored for the associated statistical feature.

For highest accuracy, each adjustment trend may determined by extracting values of the associated statistical feature for the measured signal at various levels of signal to noise ratio when the measured signal is known to match the model signal, to see how the values of the statistical feature vary with signal to noise ratio. However, this determination could be supplemented with deliberately adding noise to the model signal, or to one of the measured signals that is known to match the model signal, for example if an insufficient number of measured signals that are known to match the model signal and that have varying signal to noise ratios are available.

Advantageously, the step of comparing the adjusted values to the values of the statistical features for the model signal may comprise setting an acceptance range for each statistical feature according to the value of the statistical feature for the model signal; and determining for each statistical feature whether the adjusted value of the statistical feature falls within the acceptance range of the statistical feature. Then a definite yes/no indication is given as to whether the values of a particular statistical feature for the model signal and the measured signal match one another sufficiently well.

The acceptance range may for example be set to have its arithmetic or geometric centre at the value of the statistical feature for the model signal, and to cover a margin below the centre and a margin above the centre. The size of the margin may for example be set according to whether minimising false positives (in which case a smaller margin should be used) or minimising false negatives (in which case a larger margin should be used) is more important for the particular application.

The model signal may be a noiseless model signal, for example an ideal version of the signal that is being searched for. Alternatively, the model signal itself may comprise noise, and so the step of comparing the values of the statistical features for the model signal to the values of the statistical features for the measured signal according to the signal to noise ratio of the measured signal may comprise comparing according to a difference, between the signal to noise ratio of the model signal and the signal to noise ratio of the measured signal.

If the model signal comprises noise, then the values of the statistical features for the model signal are preferably extracted from multiple instances of the model, to help average out the effects of the noise on the values of the statistical features. Then, the value of each statistical feature for the model signal is the mean of the values of the statistical feature over the multiple instances of the model signal. Furthermore, a standard deviation may be associated with each mean, the standard deviation specifying the variation in the values of the statistical feature over the multiple instances of the model signal.

Alternatively, if multiple instances of measured signals that are known to correspond to the model signal are available at the signal to noise ratio of the model signal, then the values of the statistical features for the multiple instances of the measured signals may be used to determine the mean and the standard deviation of the values of each statistical feature for the model signal.

The mean and the standard deviation of the values of each statistical feature for the model signal may be stored in a model of that statistical feature for the model signal. There may be one model per statistical feature per model signal. For example if A signals are being searched for in the system, and each of the A signals are described in terms of B statistical features, then there are A*B models.

Advantageously, the mean and the standard deviation of the values of the statistical feature for the model signal may be used to help set the acceptance range. The acceptance range may be stored as part of the model. The acceptance range may for example be defined to cover a certain number of standard deviation values either side, of the mean.

During the comparison of the measured signal to the model signal according to the signal to noise ratio of the measured signal, the value of each statistical feature for the measured signal may be adjusted according to the respective adjustment trend by an amount depending upon the signal to noise ratio of the measured signal. The adjusted value of the statistical feature may then be compared to the mean and the standard deviation of the model of the statistical feature for the model signal, for example by asking whether the adjusted value of each statistical feature falls within the acceptance range, the acceptance range having a centre defined by the mean and a width defined by the standard deviation.

The values of each statistical feature for the model signal may be extracted from multiple instances of the model signal at each one of multiple signal to noise ratios of the model signal to determine a range trend of the standard deviation of the values of each statistical feature. The range trend may define how the standard deviation of each statistical feature varies with the signal to noise ratio of the model signal. The range trend may be stored within the model of the statistical feature.

The step of setting the acceptance range for each statistical feature according to the mean and the standard deviation of the statistical feature may comprise adjusting the standard deviation of the statistical feature according to the range trend of the statistical feature and the signal to noise ratio of the measured signal, and setting the acceptance range for the statistical feature according to the mean and the adjusted standard deviation. Accordingly, the extent of the acceptance range may be set according to the signal to noise ratio of the measured signal, which has been found to significantly improve the effectiveness of the matching of the measured signal to the model signal.

To summarise a preferred embodiment of the invention, an adjustment trend for the value of each one of the statistical features for the measurement signal is used to determine how the value of the statistical feature for the measurement signal should be adjusted according to the signal to noise ratio of the measurement signal, and a range trend for the value of each one of the statistical features for the model signal is used to set the extent of the acceptance range for the statistical feature according to the signal to noise ratio of the measurement signal, prior to comparing the adjusted value of the statistical, feature for the measurement signal to the acceptance range of the model for the statistical feature. The acceptance range is centred about the mean of the statistical feature for the model signal.

If the model signal was a noiseless model signal, then multiple instances of the model signal would all, be the same as one another. Accordingly, there would be no variance of the values of each statistical feature for multiple instances of the model signal, and the mean of each statistical feature for the model signal would be the same value as all the values of the statistical feature for the multiple instances of the model signal. However, in order to provide acceptance ranges for comparison to adjusted values of statistical features for the noisy measured signal, the variance of the values for each statistical feature could still be defined based upon the variance of the values of multiple instances of previously measured noisy signals that are known to correspond to the model signal. Preferably, the variance is defined based upon a range trend and a signal to noise ratio of the measured signal, the range trend having been determined from the multiple instances of the previously measured signals that are known to correspond to the model signal.

Many different statistical features may be used for matching the measured signal to the model signal, the certainty of the match improving for each additional statistical feature for which the value of the statistical feature for the measurement signal sufficiently matches the value of the statistical feature for the model signal when the relative signal to noise ratios of the model signal and the measurement signal are taken into account.

There are a large variety of statistical features which may be measured for the matching, for example the statistical features may include variances, means, modes, skews, or kurtosis of the signal amplitudes, phases, frequencies, powers, or components specific to a given application, e.g. MFCCs for speaker recognition. Relative differences between the values of the statistical features for the model signal and the statistical features for a reference signal may also be used as statistical features. Relative differences between the values of the statistical features for different'time segments of the model/measured signal may also be used as statistical features.

For example, one of the statistical features may be a correlation between a reference signal and the model signal, wherein the reference signal is a known signal that forms part of the model signal. The reference signal may for example be what a particular time segment of the model signal would look like if that particular time segment of the model signal did not comprise any noise. Further statistical features will also be apparent to those skilled in the art.

For the avoidance of any doubt, when a first entity is stated herein as being set according to a second entity, that is considered to include the case where the first entity is set according to both the second entity and a third entity, or according to all of second to n^{th} entities.

According to another embodiment of the invention, there is provided a signal processor configured to implement the above-described method. The signal processor is configured to obtain values of statistical features for the model signal, obtain values of the statistical features for the measured signal, and obtain the signal to noise ratio of the measured signal. Then, the signal processor is configured to compare the values of the statistical features for the model signal to the values of the statistical features for the measured signal according to the signal to noise ratio of the measured signal, to determine whether the measured signal matches the model signal.

The signal processor may obtain one or more of the values of statistical features for the model signal, the values of the statistical features for the measured signal, and the signal to noise ratio of the measured signal, by calculating them from a received model signal(s) and/or measured signal(s), or the signal processor may obtain one or more of the values by receiving them directly from another part of a system comprising the signal processor. The signal processor may for example be a Digital Signal Processor (DSP).

### BRIEF DESCRIPTION OF THE DRAWINGS

Illustrative embodiments of the invention will now be described by way of example only, and with reference to the accompanying drawings, in which:

FIG. 1 shows a table of ten different signals S1-S10 that are used to demonstrate various embodiments of the invention;

FIG. 2 shows a timing diagram of an example of the signal S1 having a signal to noise ratio of 21 dB;

FIG. 3 shows a graph of the mean variance value of the signals S1-S10 across a range of signal to noise ratios;

FIG. 4a shows a table of percentages of measured signals correctly matched to model signals when using a variance statistical feature and a fixed acceptance range, when adjusting variance in accordance with signal to noise ratio;

FIG. 4b shows a table of percentages of measured signals incorrectly matched to model signals when using a variance statistical feature and a fixed acceptance range, when adjusting variance in accordance with signal to noise ratio;

FIG. 5a shows a table of percentages of measured signals correctly matched to model signals when using a variance statistical feature and a fixed acceptance range, without adjusting variance in accordance with signal to noise ratio;

FIG. 5b shows a table of percentages of measured signals incorrectly matched to model signals when using a variance statistical feature and a fixed acceptance range, without adjusting variance in accordance with signal to noise ratio;

FIG. 6 shows a graph of the standard deviation of the variance values of the signals S1-S10 across a range of signal to noise ratios;

FIG. 7a shows a table of percentages of measured signals correctly matched to model signals when using a variance statistical feature and a variable acceptance range, when adjusting variance in accordance with signal to noise ratio;

FIG. 7b shows a table of percentages of measured signals incorrectly matched to model signals when using a variance statistical feature and a variable acceptance range, when adjusting variance in accordance with signal to noise ratio;

FIG. 8a shows a comparison between the data of the tables shown in FIGS. 4a, 5a, and 7a;

FIG. 8b shows a comparison between the data of the-tables shown in FIGS. 4a, 5a, and 7a;

FIG. 9 shows a correlation between the signal S1 and a reference signal;

FIG. 10 shows a graph of mean correlation values of the signals S1-S10 across a range of signal to noise ratios;

FIG. 11a shows a table of percentages of measured signals correctly matched to model signals when using a correlation statistical feature and a fixed acceptance range, when adjusting correlation in accordance with signal to noise ratio;

FIG. 11b shows a table of percentages of measured signals incorrectly matched to model signals when using a correlation statistical feature and a fixed acceptance range, when adjusting correlation in accordance with signal to noise ratio;

FIG. 12a shows a table of percentages of measured signals correctly matched to model signals when using a correlation statistical feature and a fixed acceptance range, without adjusting correlation in accordance with signal to noise ratio;

FIG. 12b shows a table of percentages of measured signals incorrectly matched to model signals when using a correlation statistical feature and a fixed acceptance range, without correlation variance in accordance with signal to noise ratio;

FIG. 13 shows a graph of the standard deviation of the correlation values of the signals S1-S10 across a range of signal to noise ratios;

FIG. 14a shows a table of percentages of measured signals correctly matched to model signals when using a correlation statistical feature and a variable acceptance range, when adjusting correlation in accordance with signal to noise ratio;

FIG. 14b shows a table of percentages of measured signals incorrectly matched to model signals when using a correlation statistical feature and a variable acceptance range, when adjusting correlation in accordance with signal to noise ratio;

FIG. 15a shows a comparison between the data of the tables shown in FIGS. 11a, 12a, and 14a;

FIG. 15b shows a comparison between the data of the tables shown in FIGS. 11b, 12b, and 14b;

FIG. 16 shows a flow diagram of a method for determining whether a measured, signal matches a model signal according to one embodiment of the present invention.

### DETAILED DESCRIPTION

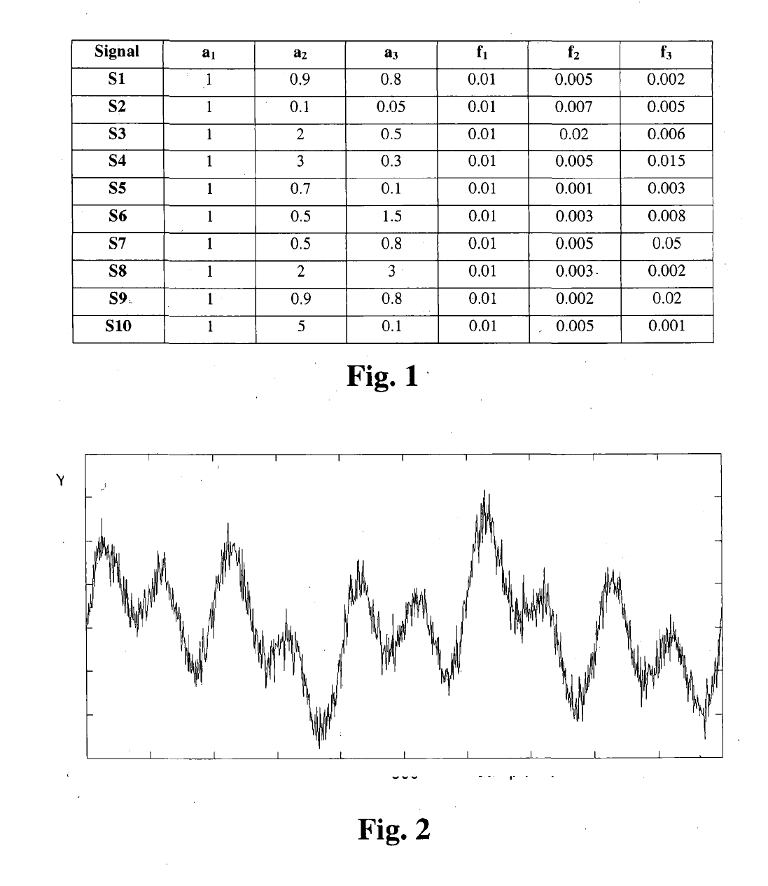

The table of FIG. 1 shows ten signals S1-S10, which are used to demonstrate various embodiments of the invention. Note that the signals S1-S10 are nominal signals chosen for illustration purposes. The signals S1-S10 are all of the form x(t)=a₁.sin(2πf₁t)+a₂.sin(2πf₂t)+a₃.sin(2πf₃t), and the coefficients a₁, a₂, a₃, f₁, f₂, f₃ for each of the signals S1-S10 are given in the FIG. 1 table.

If a measured signal matches a model signal, then the measured signal is deemed to be the same as the model signal, but may have a different signal to noise ratio from the model signal. Accordingly, the demonstration comprises determining values of a statistical feature of the ten signals when at a signal to noise ratio of 21 dB, determining values of the statistical feature of the ten signals when the ten signals are at signal to noise ratios ranging between 25 dB and 1 dB, and then checking how well the statistical feature (when used according to embodiments of the invention) matches the ten signals at signal to noise ratios between 25 dB and 1 dB to the ten signals at a signal to noise ratio of 21 dB. The signal to noise ratio of 21 dB and the signal to noise ratio range of 25 dB to 1 dB are chosen purely for illustration purposes.

Firstly, white noise n(t) was added to each of the signals S1-S10, the added noise resulting in a signal to noise ratio of 21 dB for each of the signals S1-S10. The signals S1-S10 with the added noise are therefore in the form y(t)=a₁.sin(2πf₁t)+a₂.sin(2πf₂t)+a₃.sin(2πf₃t)+n(t). FIG. 2 shows an example of the signal S1 with the added white noise n(t) at the signal to noise ratio of 21 dB. The sampling rate was 1 MHz, such that FIG. 2 covers a time span of 0.1 seconds.

The signals S1-S10 with noise at 21 dB are taken as model signals, for the matching of measured signals to these model signals.

A first embodiment of the invention using the signals S1-S10 of FIG. 1 will now be described, wherein the variance of the model signals is taken as a statistical feature for matching measured signals to the model signals.

In a first step, in order to calculate the value of the statistical feature (the variance) for the model signal S1, 1000 examples of the signal S1 with noise at 21 dB were generated. The variance value of each one of the 1000 example signals was then calculated, providing 1000 variance values. A model of the statistical feature was defined, the model comprising the mean of the 1000 variance values, and the standard deviation of the 1000 variance values. Accordingly, the model comprises the mean of the statistical feature and the standard deviation of the statistical feature, for the model signal S1 at 21 dB signal to noise ratio. 1000 examples of each of the signals S2-S10 at a signal to noise ratio of 21 dB were also, generated, and corresponding models for the statistical feature (variance value) of each one of the signals S2-S10 were also generated.

In a real embodiment, the 1000 examples used to generate the model may for example be 1000 examples of someone speaking at a given signal to noise ratio. Alternatively, a lower number of examples may be used, particularly if the examples are available at a higher signal to noise ratio. As a further alternative, if an example of the person speaking at a very high signal to noise ratio is available, then the mean of the statistical feature may simply be taken as the value of the statistical feature for that example of the person speaking, and the standard deviation of the statistical feature may be artificially generated by generating 1000 examples of the very high signal to noise ratio signal with noise artificially added to it. The noise level that is artificially added to it should roughly correspond to the expected noise level of the measured signals, for example in the middle of the range of, noise levels that may be expected to be present in the measured signals.

For each model, the mean of the statistical feature and the standard deviation of the statistical feature are used to define an acceptance range. In the particular embodiments described here, the acceptance range is set to extend to two standard deviations on either side of the mean of the statistical feature. The acceptance range is used during comparisons between statistical feature values of measured signals and the model, as described later herein.

In a second step, in order to determine how signal to noise ratio affects the Value of the statistical feature (variance value), 1000 examples of the signal Si were generated at a signal to noise ratio of 25 db, another 1000 examples of the signal Si were generated at a signal to noise ratio of 24 dB, another 1000 examples of the signal Si were generated at a signal to noise ratio of 23 dB, and so on at integer steps of signal to noise ratio, down to 1 dB of signal to noise ratio.

At each level of signal to noise ratio the variance value of the corresponding 1000 example signals of the signal S1 was calculated, and the mean of the 1000 resulting variance values was calculated.

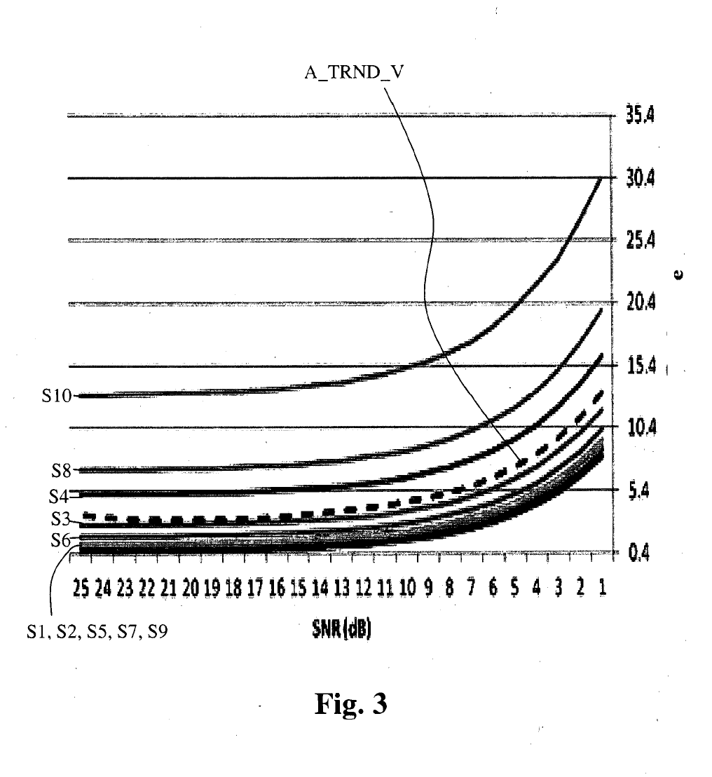

The same procedure was repeated for the signals S2-S10, and FIG. 3 shows a graph of the mean variance value against the signal to noise ratio for each one of the signals S1-S10. It can be seen that each of the signals S1-S10 have differing mean variance values, and that the mean variance values tend to increase with greater noise levels (lower signal to noise ratios). The average trend of the variance values is shown by a trend line A_TRND_V.

In a real embodiment, in order to determine how signal to noise ratio affects the value of a statistical feature (variance value) of a measured signal, many examples of the measured signal may be taken at different signal to noise ratios, or a single measured signal may have various levels of white noise artificially added to it to create many different instances of the measured signal from which an adjustment trend can be determined.

Now that ten models for the ten signals S1-S10 have been generated, each model corresponding to the statistical feature of variance value, and that an adjustment trend A_TRND_V has been defined for the statistical feature of variance value, to predict how the variance value will change with signal to noise ratio, measured signals to be matched to the model signals will be defined.

In a third step, 1000 measured signals of S1 are generated at a signal to noise ratio of 21 dB, and each one of these signals is compared to each of the models for the signals S1-S10. The comparison comprises calculating the variance value of the signal, adjusting the variance value of the signal according to the adjustment trend A_TRND_V, and asking whether the adjusted value is within the acceptance range of the model being compared to.

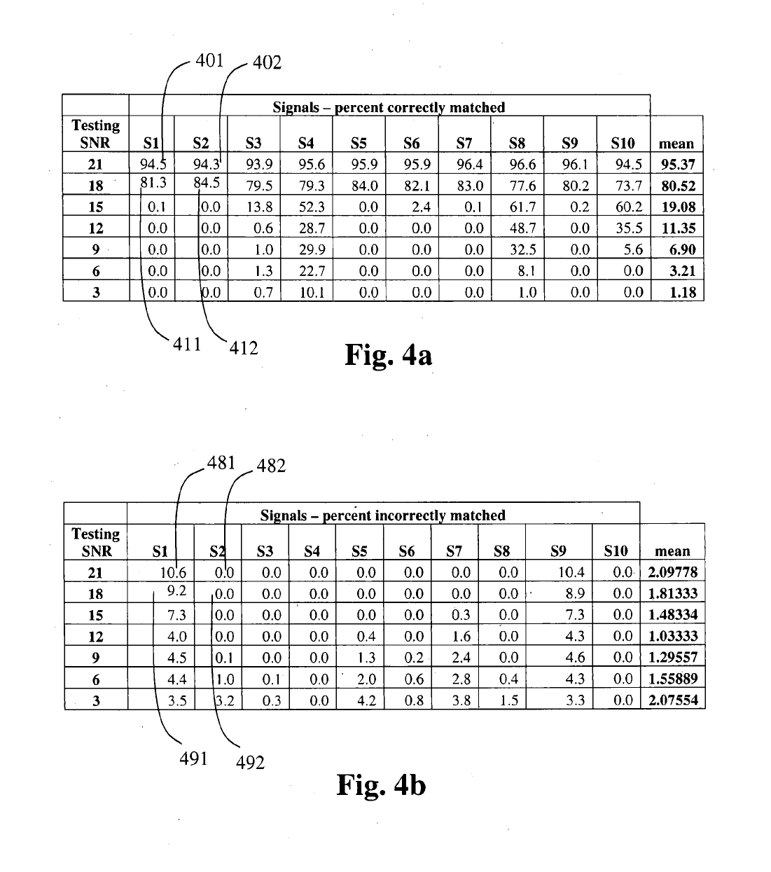

Since the signal to noise ratio of the 1000 signals of S1 is 21 dB, and the signal to noise ratio of the model signals used to generate the models in step 1 above was 21 dB, the adjustment trend A_TRND_V requires zero adjustment to the variance value of each signal as the signal to noise ratios are the same. The percentage of the 1000 signals of S1 that have a variance value falling within the acceptance range of the model for S1, i.e. the percentage of the 1000 signals of S1 that are correctly matched to the S1 model, is stored in the cell 401 of the table shown in FIG. 4a.

1000 measured signals of S2 are also generated at a signal to noise ratio of 21 dB, and each one of these signals is also compared to each of the models for the signals S1-S10, and the percentage of the 1000 measured signals of S2 that have a variance value falling within the acceptance range of the model for S2 is stored in the cell 402 of FIG. 4a. 1000 measured signals of each one of S3-S10 are also generated at a signal to noise ratio of 21 dB, and each one of these signals is compared to each of the models for the signals S1-S10 to populate the remaining cells of the 21 dB row of the FIG. 4a table.

The percentage values for the 21 dB row of the FIG. 4 table are all around 95%, and this is not surprising since sets of the same signal at 21 dB noise are being compared to one another using the criteria of whether one set is within two standard deviations of the mean of another set, it being known that for normal distributions 95% of data falls within two standard deviations of the mean.

The table of FIG. 4b shows the percentages of measured signals that were incorrectly matched. For example, cell 481 indicates that 10.7% of the 9,000 signals S2-S10 at 21 dB were incorrectly matched to the signal S1, and cell 482 indicates that none of the 9,000 signals S1 and S3-S10 at 21 dB were incorrectly matched to the signal S2.

Next, 1000 measured signals of S1 are generated at a signal to noise ratio of 18 dB, and each one of these measured signals is compared to each of the models for the signals S1-S10. The comparison comprises calculating the variance value of the measured signal, adjusting the variance value of the measured signal according to the difference between the signal to noise ratio of the measured signal (18 dB) and the signal to noise ratio of the model (21 dB), and asking whether the adjusted value is within the acceptance range of the model.

The variance value of each measured signal is adjusted according to the adjustment trend A_TRND_V. Specifically, the variance value of each one of the 1000 measured signals of S1 at 18 dB is adjusted to the value that the adjustment trend A_TRND_V predicts the variance value would have been, had the signal been at a signal to noise ratio of 21 dB, i.e. the signal to noise ratio of the model signal. This comprises adjusting each variance value by −0.08, since −0:08 is the difference between the value of the adjustment trend A_TRND_V at 18 dB (3.15) and the value of the adjustment trend TRDN at 21 dB (3.07). In this example, the value of the difference in the adjustment trend A_TRND_V between different signal to noise ratios is used as the adjustment that is applied to the variance values of the measured signals, although alternative methodologies of applying the adjustment trend to the variance values of the measured signals are also possible, for example the percentage change in the adjustment trend A_TRND_V between the signal to noise ratios of 18 dB and 21 dB may be used instead of the value of the difference. Furthermore, the individual trend of the signal S1 shown on FIG. 3 could have been used instead of the adjustment trend A_TRND_V, the adjustment trend A_TRND_V being the average of the individual trends of the signals S1-S10.

The percentage of the 1000 measured signals of S1 that have an adjusted variance value falling within the acceptance range of the model for S1, i.e. the percentage of the 1000 signals of S1 that are correctly matched to the S1 model, is stored in the cell 411 of the table shown in FIG. 4a.

1000 measured signals of S2 are also generated at a signal to noise ratio of 18 dB, and each one of these measured signals is compared to each of the models for the signals S1-S10. The variance values of the 1000 measured signals of S2 are calculated and adjusted using the same methodology as for the 1000 measured signals of S1 above. The percentage of the 1000 measured signals of S2 that have an adjusted variance value falling within the acceptance range of the model for S2 is stored in the cell 412 of FIG. 4a. 1000 measured signals of each one of S3-S10 are also generated at a signal to noise ratio of 18 dB, and each one of these signals is compared to each of the models for the signals S1-S10 to populate the remaining cells of the 18 dB row of the FIG. 4a table.

Referring again to the table of FIG. 4b, cell 491 indicates that 9.2% of the 9,000 signals S2-S10 at 18 dB were incorrectly matched to the signal S1, and cell 492 indicates that none of the 9,000 signals S1 and S3-S10 at 18 dB were incorrectly matched to the signal S2.

The methodology outlined above was repeated with 1000 signals for each of S1-S10, at 15, 12, 9, 6, and 3 dB, to complete the remaining rows of the FIG. 4a and FIG. 4b table. The percentages of measured signals that are correctly matched to the model signals drop dramatically from 15 dB onwards, although for simplicity this illustratory embodiment only uses one statistical feature to perform the matching, whereas in practice multiple statistical features would typically be used in combination to deliver better results.

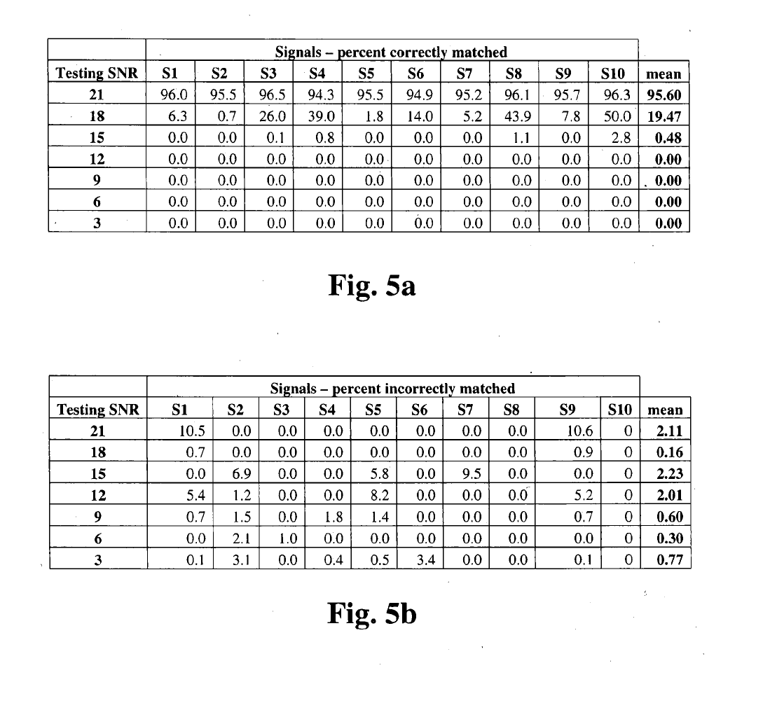

For comparison purposes, the tables of FIG. 5a and FIG. 5b show the results when the same methodology as described in relation to the tables of FIG. 4a and FIG. 4b is used, but without any adjustment of the variance values according to signal to noise ratio. It can be seen from the final columns of FIG. 4a and FIG. 5a, showing the mean percentage values, that the matching performance of the method is much higher when variance value adjustments according to the invention are carried out.

An extension of the first embodiment will now be described wherein the acceptance ranges, as well as the actual values of the variances, are varied according to signal to noise ratio.

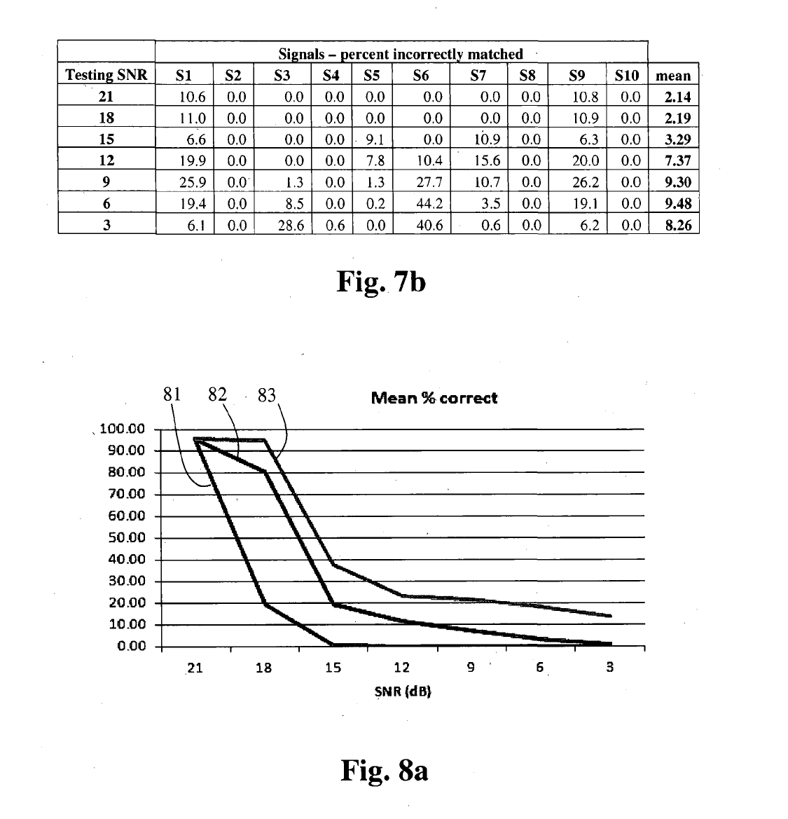

The same sets of signals with the same methodologies as used to populate the FIG. 4a and FIG. 4b tables are now used to populate the tables of FIG. 7a and FIG. 7b, except for that in the second step of determining how signal to noise ratio affects the value of the statistical feature (variance value), the method is extended to determine the standard deviation of the variance values at each of the signal to noise ratios, in addition to the mean of the variance values at each of the signal to noise ratios. The standard deviation of the variance values at each of the signal to noise ratios is used in the third step to adjust the extent of the acceptance range.

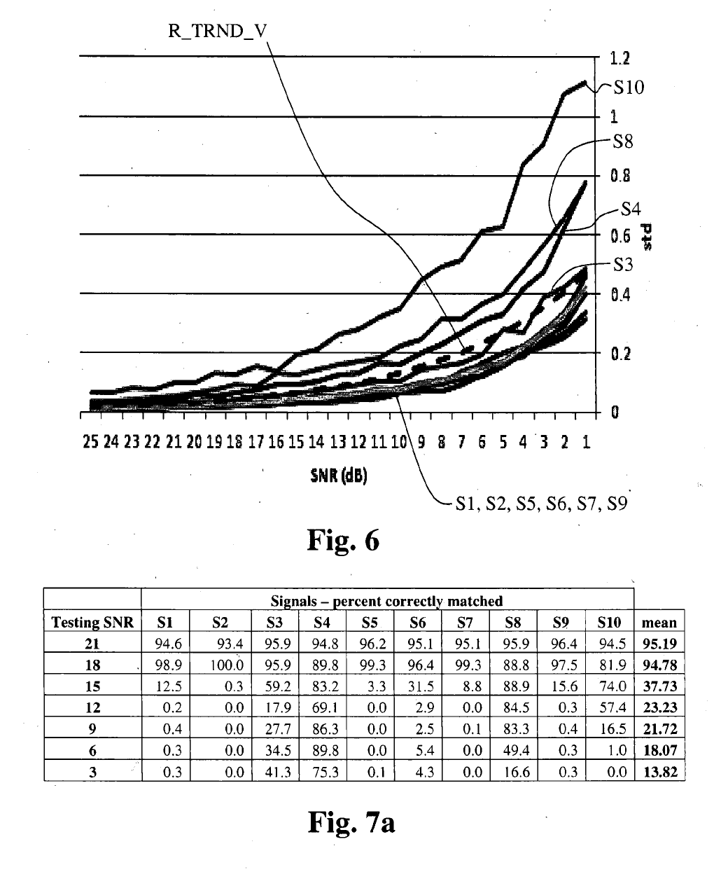

FIG. 6 shows a graph of the standard deviation of the variance values at different signal to noise ratios. For example, whereas FIG. 3 shows that the mean of the variance values of the 1000 examples of the signal S1 at 1 dB is around 8, FIG. 6 shows that the standard deviation of the variance values of the 1000 examples of the signal S1 at 1 dB is around 0.4. The standard deviations for the 1000 examples of each one of S2-S10 are also plotted on FIG. 6.

FIG. 6 shows that the standard deviation of the variance values tends to increase as the signal to noise ratio reduces. In other words, as the amount of noise in a signal increases, the amount of variation between the variance values of 1000 examples of the signal also increases. This realisation that the variance value (the value of the statistical feature being measured) is more variable at lower signal to noise ratios, can be used to increase the acceptance range of the model at lower signal to noise ratios, to reduce the number of false negatives in the results.

The average of the standard deviations of the variance values for signals S1-S10 is shown on FIG. 6 by a trend line R_TRND_V, and this trend line is used as a range trend for adjusting the acceptance range in the third step of the method when comparing the adjusted value of the statistical feature (variance value) of a measured signal to the acceptance range. In particular, the standard deviation that was used to set the acceptance range in the first step is adjusted according to the range trend and the signal to noise ratio of the measured signal, and the acceptance range is set according to the adjusted standard deviation. In this example embodiment, the acceptance range is set to extend to two standard deviations either side of the mean of the statistical feature (variance value), the standard deviation being the standard deviation given by the range trend R_TRND_V at the signal to noise ratio of the measured signal.

For example, the model relating to the statistical feature of variance value for the Si signal at 21 dB has a mean of 1.35 (see FIG. 3),, and a standard deviation of 0.02 (see FIG. 6). Accordingly, the acceptance range for whether a measured signal at 21 dB is matches the S1 signal is 1.35 plus or minus 2*0.02.

If a measured signal is received that has a variance value of 9.7 at 2 dB, then to determine whether the measured signal matches the S1 signal, the acceptance range for the S1 signal of 1.35 plus or minus 2*0.02 at 21 dB is adjusted according to the range trend R_TRND_V to give an acceptance range valid for 2 dB, the variance value of 9.7 at 2 dB is adjusted according to the adjustment trend A_TRND_V to give a variance value valid for 21 dB, and then the adjusted variance value is checked to see whether it falls within the adjusted acceptance range.

Specifically, since the range trend R_TRND_V shows the standard deviation changes from 0.03 at 21 dB to 0.4 at 2 dB (see FIG. 6), a change of 0.37, the acceptance range is adjusted from 1.35 plus or minus 2*0.02 to 1.35 plus or minus 2*0.39. Hence, the acceptance range is widened by 2*0.37 to take account of the lower signal to noise ratio of the measured signal compared to the model signal.

Furthermore, since the adjustment trend A_TRND_V shows the variance value changes from 11.2 at 2dB to 3.0 at 21dB (see FIG. 3), a change of −8.2, the variance value of 9.7 is adjusted by −8.2 to 1.5.

Finally, the method asks whether the adjusted variance value of 1.5 falls within the adjusted acceptance range of 1.35 plus or minus 2*0.39. Since the adjusted variance value of 1.5 does fall within the adjusted acceptance range of 1.35 plus or minus 2*0.39, the measured signal is determined to match the model signal S1.

The method therefore recognises that the mean and the standard deviation of the Si model for the statistical feature of variance value are valid at 21 dB, whereas the measured signal variance value of 9.7 is valid at 2 dB. The value of 9.7 is adjusted by −8.2 to the value it would most likely have been at if the measured signal was received at 21 dB, so that the adjusted value can be validly compared to the mean of 1.35. The standard deviation of the model is adjusted to the value it would have been at if the model had been generated at 2 dB, so that the acceptance range of the model accounts for the larger spread of variance values expected from the measured signal, the larger spread due to the measured signal being taken at 2 dB rather than 21 dB.

Note that the spread of the measured signal at 2 dB is not affected by subtracting the variance value of 8.2, which is why the standard deviation for the acceptance range still benefits from adjustment prior to comparing the adjusted variance value to the acceptance range. For example, if a plurality of the measured signals were received, then the difference between the lowest variance value and highest variance value would still remain the same, even if a fixed quantity such as 8.2 was subtracted from each of them.

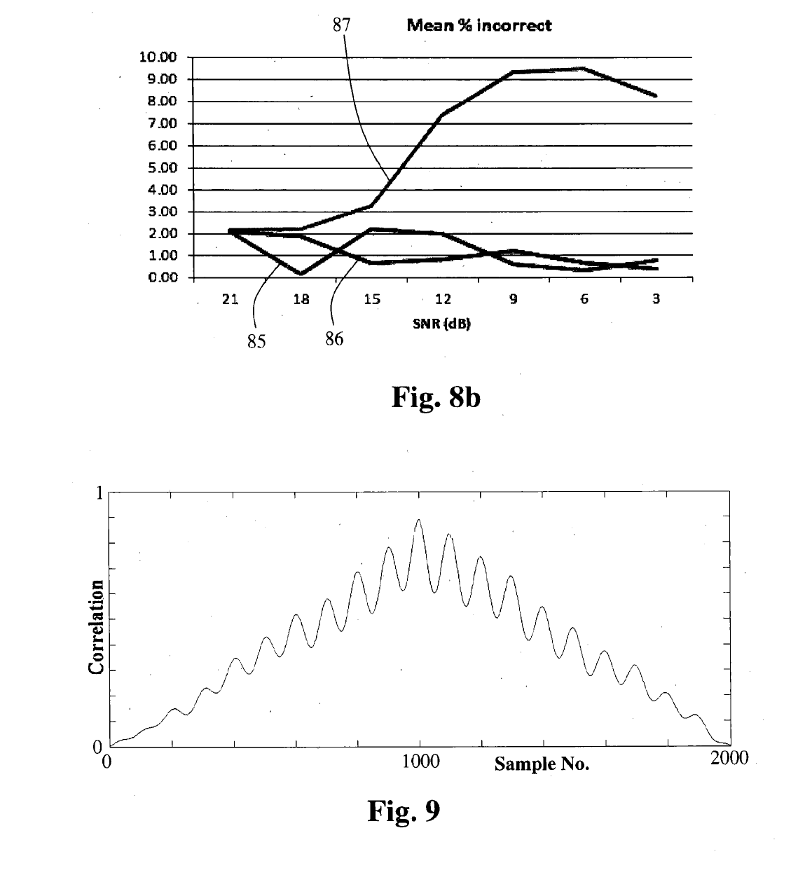

FIG. 8a shows a graph of the mean percentage of signals correctly identified as a model signal using measured signal variance value as a statistical feature over a range of signal to noise ratios. In particular, FIG. 8a shows:
a trace 81 of the data in the last column of FIG. 5a, which corresponds to signal matching without any adjustment of measured signal variance value according to signal to noise ratio, not in accordance with the invention;
a trace 82 of the data in the last column of FIG. 4a, which corresponds to signal matching with adjustment of measured signal variance value according to signal to noise ratio, in accordance with the first embodiment of the invention; and
a trace 83 of the data in the last column of FIG. 7a, which corresponds to matching with adjustment of measured signal variance value according to signal to noise ratio, and adjustment of acceptance range according to signal to noise ratio, in accordance with the extension of the first embodiment of the invention.

It is apparent from FIG. 8a that the present invention illustrated by traces 82 and 83 significantly increases the effectiveness of using statistical features to match measured signals to model signals over a range of different signal to noise ratios. The method is most effective at identifying the measured signals that correspond to the model signals S1-S10 when both the measured signal variance value is adjusted according to signal to noise ratio, and the acceptance range is adjusted according to signal to noise ratio, as shown in trace 83.

FIG. 8b shows a graph of the mean percentage of signals incorrectly identified as a model signal using measured signal variance value as a statistical feature over a range of signal to noise ratios. In particular, FIG. 8b shows:
a trace 85 of the data in the last column of FIG. 5b, which corresponds to signal matching without any adjustment of measured signal variance value according to signal to noise ratio, not in accordance with the invention;
a trace 86 of the data in the last column of FIG. 4b, which corresponds to signal matching with adjustment of measured signal variance value according to signal to noise ratio, in accordance with the first embodiment of the invention; and
a trace 87 of the data in the last column of FIG. 7b, which corresponds to matching with adjustment of measured signal variance value according to signal to noise ratio, and adjustment of acceptance range according to signal to noise ratio, in accordance with the extension of the first embodiment of the invention.

It can be seen by comparing trace FIG. 8a and FIG. 8b that although adjusting both the measured signal variance value and the acceptance range according to signal to noise ratio does improve the number of measured signals that are correctly matched (see trace 83), the number of signals that are incorrectly matched also increase (see trace 87). Therefore whether the acceptance range is adjusted according to signal to noise ratio in addition to the value of the statistical feature, partly depends upon whether or not a higher rate of incorrect matches (false positives) can be accepted in the results.

A second embodiment of the invention using the signals S1-S10 of FIG. 1 will now be described, wherein a correlation of the signals S1-S10 to a reference signal is taken as a statistical feature for matching measured signals to model signals.

For illustration purposes, the reference signal is chosen to be r(t)=a₁sin(2πf₁t), since this is a signal that appears within each one of the signals S1-S10, and so the signals S1-S10 will all have some degree of correlation to it. Since a₁=1 and f₁=0.01 for all of S1-S10, the same reference signal of r(t)=1.sin(2π.0.01.t), is being used for calculating correlations to all of S1-S10. However, there is no reason why this must be so, and different reference signals could be used for different ones of the signals S1-S10 in alternate embodiments.

The correlation is a cross-correlation, and is taken by sliding samples of the reference signal and one of the signals S1-S10 past one another, and measuring the peak level of correlation between them. For illustration purposes, the graph of FIG. 9 shows the cross-correlation between the signal S1=a₁.sin(2πfᵢt)+a₂.sin(2πf₂t)+a₃.sin(2πf₃t) and the signal r(t)=a₁sin(2πf₁t). According to the table of FIG. 1, for S1, a₁=1, a₂=0.9, a₃=0.8, f₁=0.01, f₂,=0.005, and f₃=0.002.

1000 samples of the signals S1 and r(t) were taken and cross-correlated with one another, such that the cross-correlation shown in FIG. 9 covers 2000 samples. The correlation peak is approximately 0.9, and so in this example 0.9 is taken as the value of the statistical feature of correlation between the reference signal r(t) and the signal S1.

The same methodology as, followed in the first embodiment to illustrate the use of the statistical feature of variance, will now be followed in the second embodiment to illustrate the use of the statistical feature of correlation.

In a first step, a model for the statistical feature of correlation was created for each one of the signals S1-S10 at 21 dB. To do this, 1000 examples of each one of the signals S1-S10 with noise at 21 dB were generated. The peak correlation value of each one of the 1000 example signals to the reference signal r(t) was then calculated for each one of the signals S1-S10, providing 1000 correlation values for each one of the signals S1-S10. The mean and the standard deviation of the 1000 correlation values for each one of the signals S1-S10 were taken, and were stored in the models corresponding to the signals. For each model, an acceptance range was defined as the mean of the model plus or minus twice the standard deviation of the model.

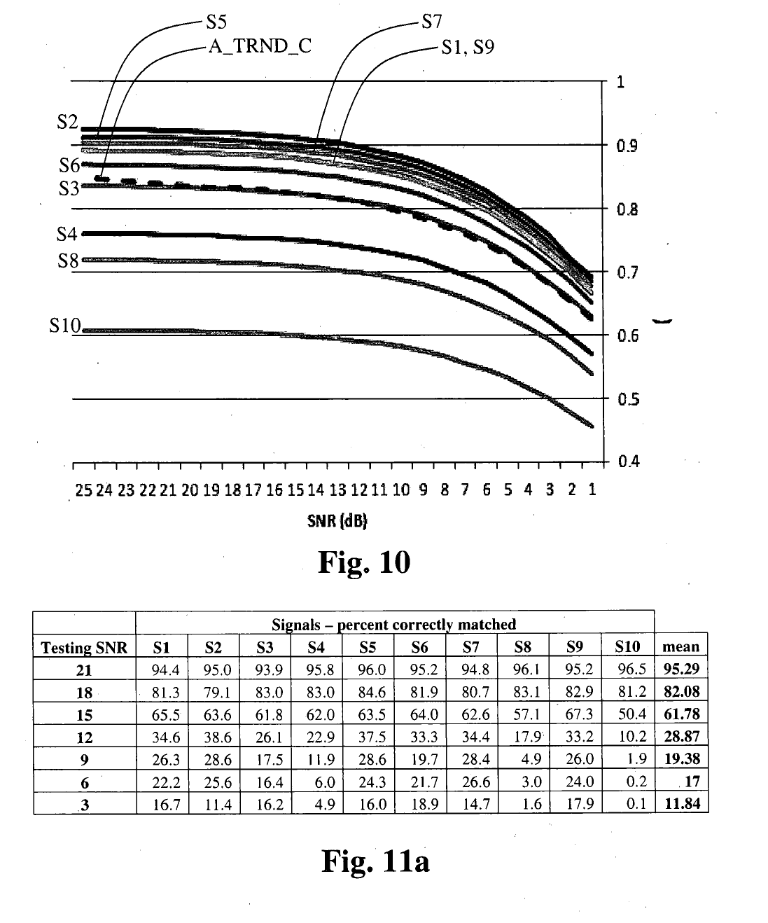

In a second step, in order to determine how signal to noise ratio affects the value of the statistical feature (correlation), 1000 examples of each one of the signals S1-S10 were generated at each one of integer steps of signal to noise ratios ranging from 25 dB down to 1 dB. FIG. 10 shows a graph of the mean correlation value against the signal to noise ratio for each one of the signals S1-S10. It can be seen that each of the signals S1-S10 have differing mean correlation values, and that the mean correlation values tend to decrease with signal to noise ratio. The average trend of the correlation values is shown by a trend line A_TRND_C.

Now that ten models for the ten signals S1-S10 have been generated, each model corresponding to the statistical feature of correlation value, and that an adjustment trend A_TRND_C has been defined for the statistical feature of correlation value, to predict how the correlation value will change with signal to noise ratio, measured signals to be matched to the model signals are defined.

In a third step, 1000 measured signals of each one of S1-S10 were generated at each one of signal to noise ratios of 21, 18, 15, 12, 9, 6, and 3 dB, i.e. 70,000 signals in total.

Each one of these signals was compared to each of the models for the signals S1-S10. The comparison comprised calculating the correlation value of the signal to the reference signal, adjusting the correlation value of the signal according to the adjustment trend A_TRND_C, and asking whether the adjusted value is within the acceptance range of the model being compared to.

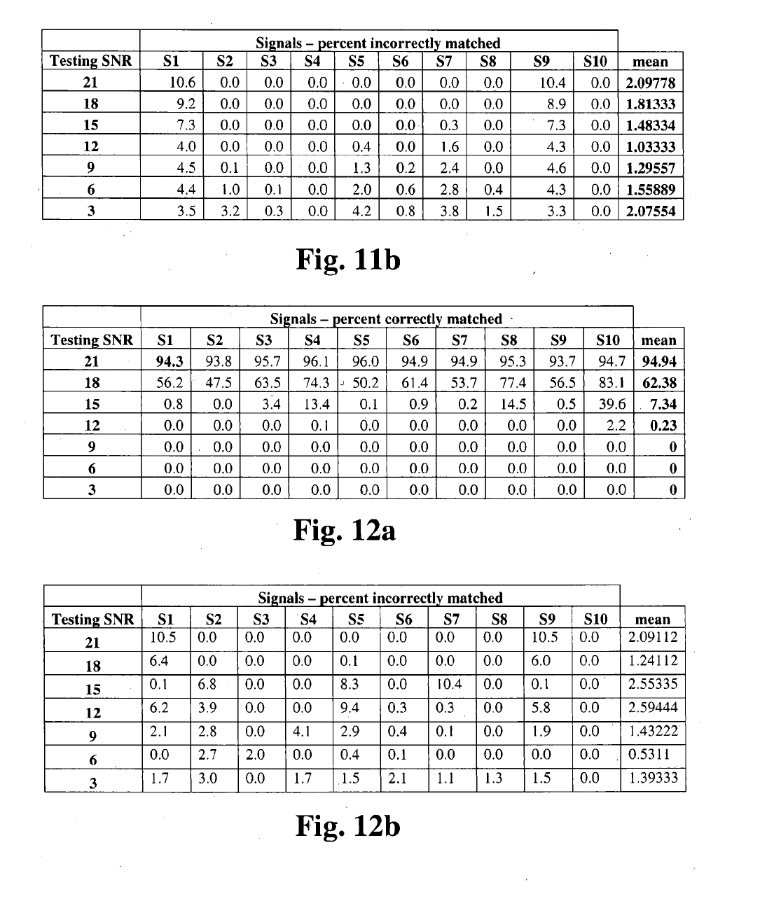

The table of FIG. 11a shows the percentages of the measured signals that were correctly matched, in a similar manner to the table of FIG. 4a in relation to the first embodiment. The table of FIG. 11b shows the percentages of measured signals that were incorrectly matched, in a similar manner to the table of FIG. 4b in relation to the first embodiment.

As in the first embodiment, the value of the difference in the adjustment trend A_TRND_C between different signal to noise ratios was used as the adjustment that was applied to the correlation values of the measured signals.

For comparison purposes, the tables of FIG. 12a and FIG. 12b show the results when the same methodology as described in relation to the tables of FIG. 11a and FIG. 11b is used, but without any adjustment of the correlation values according to signal to noise ratio. It can be seen from the final columns of FIG. 11a and FIG. 12a, showing the mean percentage values, that the matching performance of the method is much higher when correlation value adjustments according to the invention are carried out.

An extension of the second embodiment will now be described wherein the acceptance ranges, as well as the actual values of the correlations, are varied according to signal to noise ratio.

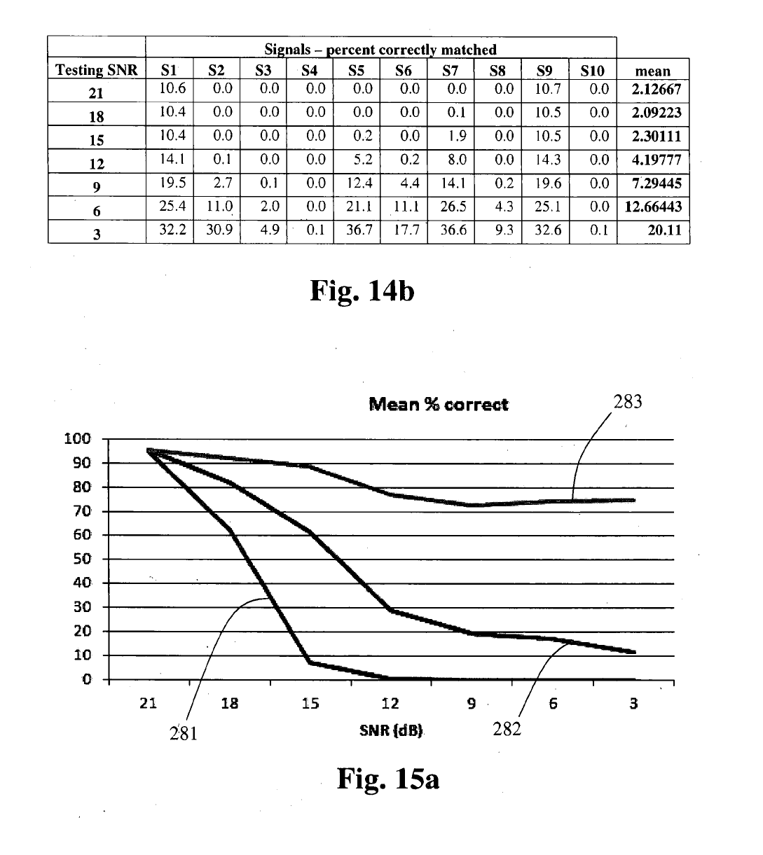

The same sets of signals with the same methodologies as used to populate the FIG. 11a and FIG. 11b tables are now used to populate the tables of FIG. 14a and FIG. 14b, except for that in the second step of determining how signal to noise ratio affects the value of the statistical feature (correlation value), the method is extended to determine the standard deviation of the correlation values at each of the signal to noise ratios, in addition to the mean of the correlation values at each of the signal to noise ratios. The standard deviation of the correlation values at each of the signal to noise ratios is used in the third step to adjust the extent of the acceptance range according to signal to noise ratio.

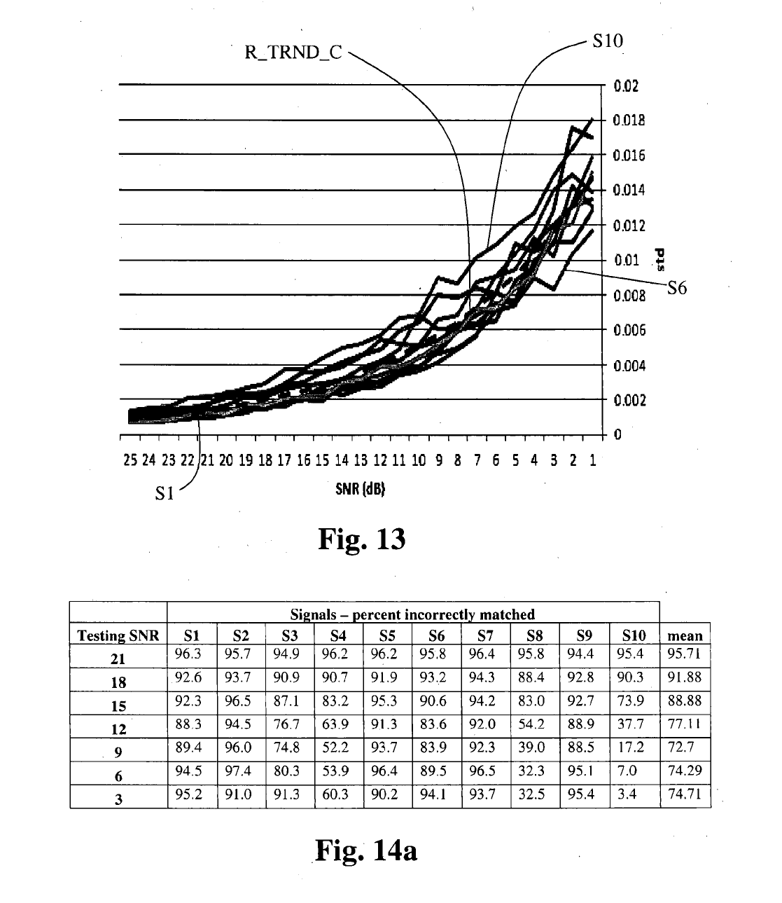

FIG. 13 shows a graph of the standard deviation of the correlation values at different signal to noise ratios. Specifically, the standard deviations for the 1000 examples of each one of S1-S10 are plotted at each one of 21, 18, 12, 9, 6, and 3 dB of signal to noise ratio. FIG. 13 shows that the standard deviation of the correlation values tends to increase as the signal to noise ratio reduces. This realisation that the correlation value (the value of the statistical feature being measured) is more variable at lower signal to noise ratios, can be used to increase the acceptance range of the model at lower signal to noise ratios, to reduce the number of false negatives in the results.

The average of the standard deviations of the correlation values for signals S1-S10 is shown on FIG. 13 by the dashed trend line R_TRND_C, and this trend line is used as a range trend for adjusting the acceptance range in the third step of the method when comparing the adjusted value of the statistical feature (correlation value) of a measured signal to the acceptance range. In particular, the standard deviation that was used to set the acceptance range in the first step is adjusted according to the range trend and the signal to noise ratio of the measured signal, and the acceptance range is set according to the adjusted standard deviation.

For example, the model relating to the statistical feature of correlation value for the Si signal at 21 dB has a mean of 0.89 (see FIG. 10), and a standard deviation of 0.00.13 (see FIG. 13). Accordingly, the acceptance range for whether a measured signal at 21 dB matches the S1 signal is 0.89 plus or minus 2*0.0013.

If a measured signal is received that has a correlation value of 0.785 at 5 dB, then to determine whether the measured signal matches the S1 signal, the acceptance range for the S1 signal of 0.89 plus or minus 2*0.0013 at 21 dB is adjusted according to the range trend R_TRND_C to give an acceptance range valid for 5 dB, the correlation value of 0.785 at 5 dB is adjusted according to the adjustment trend A_TRND_C to give a correlation value valid for 21 dB, and then the adjusted correlation value is checked to see whether it falls within the adjusted acceptance range.

Specifically, since the range trend R_TRND_C shows the standard deviation changes from 0.0014 at 21 dB to 0.0091 at 5 dB (see FIG. 13), a change of +0.0077, the acceptance range is adjusted from 0.89 plus or minus 2*0.0013 to 0.89 plus or minus 2*0.0090. Hence, the acceptance range is widened by 2*0.0077 to take account of the lower signal to noise ratio of the measured signal compared to the model signal.

Furthermore, since the adjustment trend A_TRND_C shows the correlation value changes from 0.73 at 5 dB to 0.84 at 21 dB (see FIG. 10), a change of +0.11, the correlation value of 0.785 is adjusted by +0.11 to 0.895.

Finally, the method asks whether the adjusted correlation value of 0.895 falls within the adjusted acceptance range of 0.89 plus or minus 2*0.0090. Since the adjusted correlation value of 0.895 does fall within the adjusted acceptance range of 0.89 plus or minus 2*0.0090, the measured signal is determined to match the model signal S1.

The method therefore recognises that the mean and the standard deviation of the Si model for the statistical feature of correlation value are valid at 21 dB, whereas the measured signal correlation value of 0.785 is valid at 5 dB. The value of 0.785 is adjusted by +0.11 to the value it would most likely have been at if the measured signal was received at 21 dB, so that the adjusted value can be validly compared to the mean of 0.89. The standard deviation of the model is adjusted to the value it would have been at if the model has been generated at 5 dB, so that the acceptance range of the model accounts for the larger spread of correlation values expected from the measured signal, the larger spread due to the measured signal being taken at 5dB rather than 21 dB.

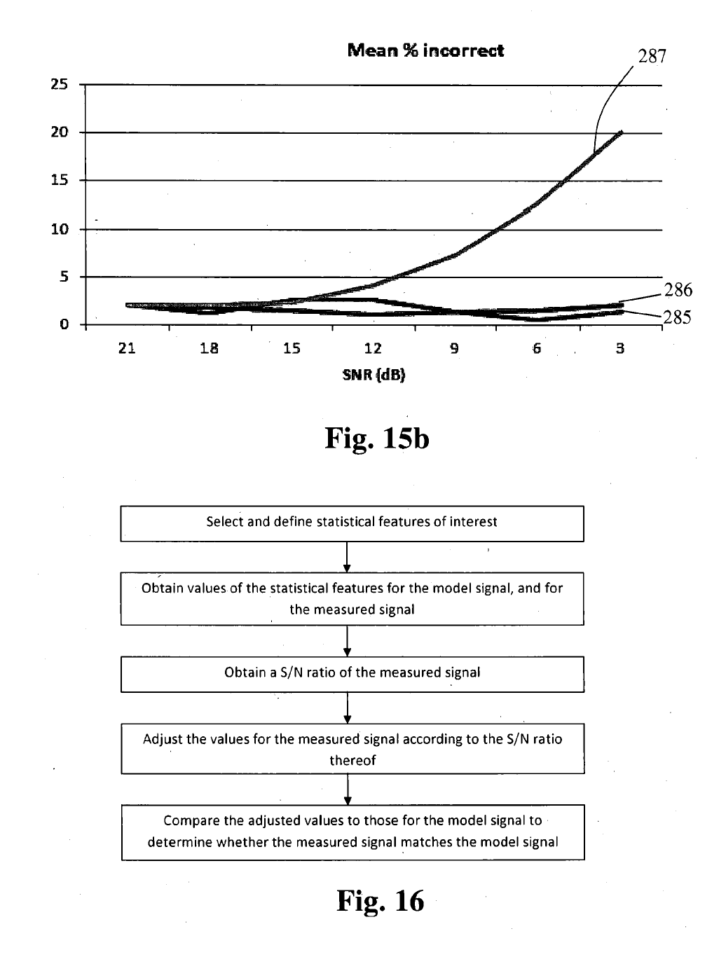

FIG. 15a shows a graph of the mean percentage of signals correctly identified as a model signal using measured signal correlation value as a statistical feature over a range of signal to noise ratios. In particular, FIG. 15a shows:
a trace 281 of the data in the last column of FIG. 12a, which corresponds to signal matching without any adjustment of measured signal correlation value according to signal to noise ratio, not in accordance with the invention;
a trace 282 of the data in the last column of FIG. 11a, which corresponds to signal matching with adjustment of measured signal correlation value according to signal to noise ratio, in accordance with the second embodiment of the invention; and
a trace 283 of the data in the last column OF FIG. 14a, which corresponds to matching with adjustment of measured signal correlation value according to signal to noise ratio, and adjustment of acceptance range according to signal to noise ratio, in accordance with the extension of the second embodiment of the invention.

It is apparent. from FIG. 15a that the present invention illustrated by traces 282 and 283 significantly increases the effectiveness of using statistical features to match measured signals to model signals over a range of different signal to noise ratios. The method is most effective at identifying the measured signals that correspond to the model signals S1-S10 when both the measured signal correlation value is adjusted according to signal to noise ratio, and the acceptance range is adjusted according to signal to noise ratio, as shown in trace 283.

FIG. 15b shows a graph of the mean percentage of signals incorrectly identified as a model signal using measured signal correlation value as a statistical feature over a range of signal to noise ratios. In particular, FIG. 15b shows:
a trace 285 of the data in the last column of FIG. 12b, which corresponds to signal matching without any adjustment of measured signal correlation value according to signal to noise ratio, not in accordance with the invention;
a trace 286 of the data in the last column of FIG. 11b, which corresponds to signal matching with adjustment of measured signal correlation value according to signal to noise ratio, in accordance with the second embodiment of the invention; and
a trace 287 of the data in the last column of FIG. 14b, which corresponds to matching with adjustment of measured signal correlation value according to signal to noise ratio, and adjustment of acceptance range according to signal to noise ratio, in accordance with the extension of the second embodiment of the invention.

It can be seen by comparing the traces of FIG. 15a and FIG. 15b that although adjusting both the measured signal correlation value and the acceptance range according to signal to noise ratio does improve the number of measured signals that are correctly matched (see trace 283), the number of signals that are incorrectly matched also increases (see trace 287). Therefore whether the acceptance range is adjusted according to signal to noise ratio in addition to the value of the statistical feature, partly depends upon whether or not a higher rate of incorrect matches (false positives) can be accepted in the results.

In a real embodiment where matching to a reference signal is used, for example in speech-recognition, the reference signal may be a relatively short time duration signal that corresponds to a particular vocal sound. The reference signal is slid over a longer time duration measured signal that corresponds to a spoken word, and the correlation gives a measure of whether and whereabouts the spoken work contains the vocal sound. Both the size of the correlation peak and the timing of the correlation peak could be used as statistical features in matching the measured signal of the spoken work to a model signal of the spoken word to determine what the word is.

Comparing the FIG. 8a results of the first embodiment to the FIG. 15a results of the second embodiment, shows that the correlation feature of the second embodiment produces better results than the variance feature of the first embodiment. In the first and second embodiments, only one statistical feature is used for the matching, although the embodiments could clearly be expanded to use additional statistical features to improve the results. For example, a system that measures both variance and correlation may be implemented, and a match of a measured signal to a model signal only established if the measured signal has both adjusted variance and adjusted correlation values within corresponding variance and correlation models of the model signal.

Alternatively, the adjusted variance and the adjusted correlation values of the measured signal could be scored according to how close they are to the mean correlation and variance values of the model signal, and then the scores added to give a final score for determining whether there is a match or not.

FIG. 16 illustrates one embodiment of the invention including the steps of: Defining statistical features of interest, Obtaining values of the statistical features for the model signal, and for the measured signal, Obtaining the S/N (signal to noise ratio) of the measured signal, Adjusting the values for the measured signal according to the S/N ratio thereof, and Comparing the adjusted values of the measured signal to those for the model signal to determine whether the measured signal matches the model signal.

Any embodiment of the invention may additionally include any combination of the following features through which it may be determined whether a measured signal matches any of a plurality of model signals:
Defining a plurality of statistical features of interest (preferably at least 10, more preferably at least 20), preferably each of which are applicable to any waveform to produce a single (and typically real) numerical value.
Determining and recording at least the values of the statistical features for a plurality of model signals (preferably at least, more preferably at least 1000) each preferably having substantially similar S/N.
Measuring, determining or adjusting the S/N of the model signals to be a known S/N.
Determining how a representative value (E.g. an average—such as mean or median) for each statistical feature varies according to the S/N of the model signals (optionally by adding noise to achieve differing levels of S/N and recalculating the values at each achieved S/N) to generate a trend thereof. The trends for each statistical feature together may directly or indirectly form a model of the model signals.
Comparing the measured signal to a model of the model signals, to identify the S/N of the measured signal based on the trends of values vs S/N therein.
Using knowledge of the S/N of the measured signal (whether identified as above or otherwise) the values of the statistical features of the measured signal can then be adjusted according to the model to produce adjusted values which represent what the values are expected to have been if the measured signal had been received or recorded at and with the known S/N (the same S/N as the model signals). The adjusted values of the measured signal can then be compared to the values of the model signals to identify if it matches any of the model signals.

Optionally, the step of comparing the values of the statistical features for the model signal to the values of the statistical features for the measured signal according to the signal to noise ratio of the measured signal to determine whether the measured signal matches the model signal, comprises the step of adjusting the values of the statistical features for the measured signal according to the signal to noise ratio of the measured signal.

Optionally, the step of comparing the values of the statistical features for the model signal to the values of the statistical features for the measured signal according to the signal to noise ratio of the measured signal to determine whether the measured signal matches the model signal, comprises the step of comparing the adjusted values to the values of the statistical features for the model signal to determine whether the measured signal matches the model signal.

Various other embodiments of the invention falling within the scope of the appended claims will also be apparent to those skilled in the art.

1. A method for determining whether a measured signal matches a model signal, the method comprising:
defining statistical features;
obtaining values of the statistical features for the model signal;
obtaining values of the statistical features for the measured signal;
obtaining a signal to noise ratio of the measured signal; and
comparing the values of the statistical features for the model signal to the values of the statistical features for the measured signal according to the signal to noise ratio of the measured signal to determine whether the measured signal matches the model signal, this step comprising the steps of:
adjusting the values of the statistical features for the measured signal according to the signal to noise ratio of the measured signal; and
comparing the adjusted values to the values of the statistical features for the model signal to determine whether the measured signal matches the model signal.

2. The method of claim 1 where;
Comparing according to the signal to noise ratio of the measured signal is provided by comparing according to a difference between the signal to noise ratio of the model signal and the signal to noise ratio of the measured signal , and
Adjusting according to the signal to noise ratio of the measured signal is provided by adjusting according to respective adjustment trends that are associated with the statistical features, each adjustment trend predicting how the value of the associated statistical feature for the measured signal will vary according to the signal to noise ratio of the measured signal.

3. The method of claim 1, wherein the step of adjusting the values of the statistical features comprises adjusting the values of the statistical features according to respective adjustment trends that are associated with the statistical features, each adjustment trend predicting how the value of the associated statistical feature for the measured signal will vary according to the signal to noise ratio of the measured signal.

4. The method of claim 3, wherein each adjustment trend is determined by adding various levels of noise to the model signal and extracting values of the associated statistical feature for the model signal at the various levels of noise to see how the values of the associated statistical feature for the model signal vary with signal to noise ratio.

5. The method of claim 3, wherein each adjustment trend is determined by:
measuring values of the associated statistical feature for multiple signals, wherein each one of the multiple signals has the associated statistical feature measured at a range of signal to noise ratios;
determining an individual trend for each one of the multiple signals, each individual trend predicting how the value of the associated statistical feature will vary according to the signal to noise ratio of the one of the multiple signals; and
determining the adjustment trend according to the average of the individual trends.

6. The method of claim 2, wherein the step of comparing the adjusted values to the values of the statistical features for the model signal comprises:
setting an acceptance range for each statistical feature according to the value of the statistical feature for the model signal; and
determining for each statistical feature whether the adjusted value of the statistical feature falls within the acceptance range of the statistical feature.

7. The method of claim 1, wherein the model signal comprises noise, and wherein the step of comparing the values of the statistical features for the model signal to the values of the statistical features for the measured signal according to the signal to noise ratio of the measured signal comprises comparing according to a difference between the signal to noise ratio of the measured signal and the signal to noise ratio of the model signal.

8. The method of claim 7, wherein values of each statistical feature for the model signal are extracted from multiple instances of the model signal to determine a mean and a standard deviation of the values of the statistical feature, and wherein the claim 8 step of setting an acceptance range for each statistical feature according to the value of the statistical feature for the model signal comprises setting the acceptance range of. the statistical feature according to the mean and the standard deviation of the statistical feature for the multiple instances of the model signal.

9. The method of claim 8, wherein values of each statistical feature for the model signal are extracted from multiple instances of the model signal at each one of multiple signal to noise ratios of the model signal to determine a range trend of the standard deviation of the values of each statistical feature, the range trend defining how the standard deviation of each statistical feature varies with the signal to noise ratio of the model signal, and wherein the claim 10 step of setting the acceptance range for each statistical feature according to the mean and the standard deviation of the statistical feature for the multiple instances of the model signal comprises adjusting the standard deviation of the statistical feature according to the range trend of the statistical feature and the signal to noise ratio of the measured signal, and setting the acceptance range for the statistical feature according to the mean and the adjusted standard deviation.

10. The method of claim 1, wherein one of the statistical features of the model signal is a variance value of the model signal.

11. The method of claim 1, wherein one of the statistical features is a correlation between a reference signal and the model signal.

12. The method of claim 11, wherein the reference signal is a known signal that forms part of the model signal.

13. A signal processor configured to perform the method of claim 1.

14. A method for determining whether a measured signal matches a model signal, the method comprising:
defining statistical features;
obtaining values of the statistical features for the model signal;
obtaining values of the statistical features for the measured signal;
obtaining a signal to noise ratio of the measured signal; and
comparing the values of the statistical features for the model signal to the values of the statistical features for the measured signal according to the signal to noise ratio of the measured signal to determine whether the measured signal matches the model signal.
